(19) United States
(12) Patent Application Publication
(10) Pub. No.: US 2004/0107097 A1
(43) Pub. Date: Jun. 3, 2004

(54) Method and system for voice recognition through dialect identification

(75) Inventors: Timothy D. Lenane, Royal Oak, MI (US); Michelle A. Fox, Novi, MI (US)

Correspondence Address: General Motors Corporation, 300 Renaissance Center, Mail Code 482-C23-B21, P.O. Box 300, Detroit, MI, 48265-3000, US

(73) Assignee: General Motors Corporation

(21) Appl. No.: 10/307,657

(22) Filed: Dec. 2, 2002

(51) Int. Cl. G10L 15/00

(52) U.S. Cl. 704/231

(57) ABSTRACT

The invention presents a method for automated speech recognition by accessing a customer voice recognition profile and selecting a voice recognition attribute. A modified customer voice recognition profile is created as a function of the voice recognition attribute and a voice recognition engine is amended as a function of the modified customer voice recognition profile.

### FIELD OF THE INVENTION

In general, the invention relates to wireless communication systems. More specifically, the invention relates to voice recognition within wireless communication systems and in particular, to a method and system for voice recognition through dialect identification.

### BACKGROUND OF THE INVENTION

Telematic communication units (TCU's) such as cellular phones, personal data assistants (PDA's), Global Positioning System (GPS) devices, and on-board Vehicle Communication Units (VCU's), used in conjunction with a Wide Area Network (WAN), such as a cellular telephone network or a satellite communication system, have made it possible for a person to send and receive voice communications, data transmissions, and facsimile (FAX) messages from virtually anywhere on earth. Such communication can be initiated at the TCU when it is turned on, or by entering a phone number to be called, or in many cases, by speaking a voice command to a voice recognition system (VR), causing the TCU to automatically complete the process of dialing the number to be called.

Current voice dependent VR systems use the recorded words of a user (speaker) to modify the recognition capability. A voice dependent system requires the system be trained in the speaker's own voice. This may typically take 15 minutes and require the user to navigate through a menu of choices. However, a voice dependent VR system that has been trained under one noise condition can have more difficulty recognizing the same speaker in a different noise condition.

Additionally, a problem has been identified through a marketing study conducted by Forrester entitled “Voice Portals Speak to Few”. The study indicates customer dissatisfaction with VR systems is highest (24%) for the “accuracy of voice recognition” category. Lack of correct character recognition is a major source of customer dissatisfaction of many voice recognition systems. An Owners Customer Satisfaction survey also shows that “voice recognition” is the number one customer complaint with the current technology (answered affirmatively from 37% of respondents). This lack of accuracy, whether real or perceived, has resulted in increased warranty claims for VR system repair.

A dialect VR performance study has revealed a significant deficit in recognition accuracy for members of certain ethnic groups relative to a control group. Further, it has been identified that VR performance for certain ethnic groups is particularly deficient for a variety of commands.

Thus, there is a significant need for a method and system for improving voice recognition that overcomes the above disadvantages and shortcomings, as well as other disadvantages.

### SUMMARY OF THE INVENTION

One aspect of the invention presents a method for automated speech recognition by accessing a customer voice recognition profile, selecting a voice recognition attribute, creating a modified customer voice recognition profile as a function of the voice recognition attribute, and amending a voice recognition engine as a function of the modified customer voice recognition profile.

Another aspect of the invention presents a system for automated speech recognition. The system includes means for accessing a customer voice recognition profile, means for selecting a voice recognition attribute, and means for creating a modified customer voice recognition profile as a function of the voice recognition attribute. Further, the system provides means for amending a voice recognition engine as a function of the modified customer voice recognition profile.

Another aspect of the invention provides a computer readable medium for storing a computer program for automated speech recognition. The computer program is comprised of computer readable code for accessing a customer voice recognition profile, selecting a voice recognition attribute, creating a modified customer voice recognition profile as a function of the voice recognition attribute; and amending a voice recognition engine as a function of the modified customer voice recognition profile.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram for one embodiment of a system for accessing a voice recognition system using a wireless communication system, in accordance with the current invention; and

FIG. 2 is a flow chart representation for one embodiment of a dialect identification based voice recognition method utilizing the system of FIG. 1, in accordance with the present invention.

### DETAILED DESCRIPTION OF A PREFERRED EMBODIMENT

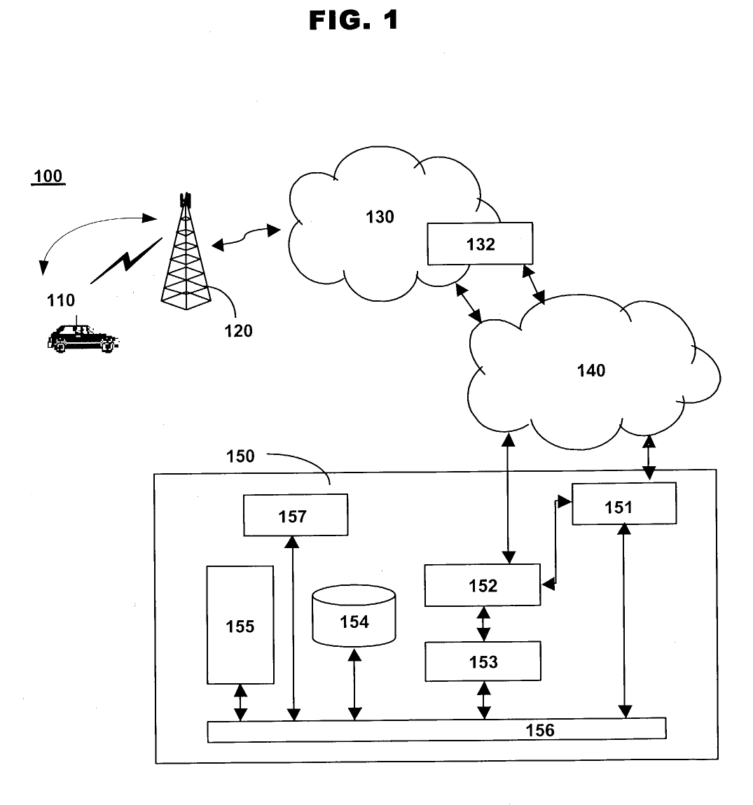

FIG. 1 shows an illustration of one embodiment of a system for communicating with a mobile vehicle using a wireless communication system in accordance with the present invention, and may be referred to as a mobile vehicle communication system (MVCS) 100. The mobile vehicle communication system 100 may contain one or more mobile vehicles (mobile vehicle communication unit, MVCU) 110, one or more wireless carrier systems (wireless service providers) 120, one or more communication networks 130, one or more short message service centers 132, one or more land networks 140, and one or more call centers 150. One embodiment of the call center 150 contains one or more switches 151, one or more data transmission devices 152, one or more communication services managers 153, one or more communication services databases 154, one or more advisors 155, one or more bus systems 156, and one or more automated speech recognition (ASR) units 157.

MCVU 110 includes a wireless vehicle communication device (module, MVCS module) such as an analog or digital phone with suitable hardware and software for transmitting and receiving data communications. In one embodiment, MCVU 110 further includes a wireless modem for transmitting and receiving data. In another embodiment, MCVU 110 includes a digital signal processor with software and additional hardware to enable communications with the mobile vehicle and to perform other routine and requested services.

Additionally, MCVU 110 includes a global positioning system (GPS) unit capable of determining synchronized time and a geophysical location of the mobile vehicle. In operation, MCVU 110 sends to and receives radio transmissions from wireless carrier system 120. MCVU 110 may also be referred to as a mobile vehicle throughout the discussion below. In operation, MCVU 110 may be implemented as a motor vehicle, a marine vehicle, or as an aircraft.

In a further embodiment, MCVU 110 contains a speech recognition system (ASR) capable of communicating with the wireless vehicle communication device, and contains a voice recognition engine (VRE) capable of word recognition. An additional embodiment of the module provides it is capable of functioning as any part of, or as all of the above communication devices and, in another embodiment of the invention, is capable of data storage, and/or data retrieval, and/or receiving, processing, and transmitting data queries.

In yet another embodiment, the MVCS module further includes an audio speaker, a synthesized voice output, an audio channel, or the like. In an example, a MVCS module is implemented, in addition to the receiver, as a set of headphones, the audio portion of a television, a display device, or the like.

Wireless carrier system 120 is a wireless communications carrier or a mobile telephone system and transmits to and receives signals from one or more MCVU 110. In one example, the mobile telephone system may be an analog mobile telephone system operating over a prescribed band nominally at 800 MHz. The mobile telephone system may be a digital mobile telephone system operating over a prescribed band nominally at 800 MHz, 900 MHz, 1900 MHz, or any suitable band capable of carrying mobile communications.

A further embodiment of the MVCS 100 provides the wireless carrier system 120 to be connected with communications network 130. One example of the communications network 130 contains a mobile switching center and provides services from one or more wireless communications companies.

Another embodiment of the MVCS 100 allows for communications network 130 to be any suitable system or collection of systems for connecting wireless carrier system 120 to at least one mobile vehicle 110 or to a call center.

Communications network 130 includes one or more short message service centers 132. Short message service center 132 is capable of prescribing alphanumeric short messages to and from mobile vehicles 110, and includes message entry features, administrative controls, and message transmission capabilities. For one embodiment of the invention, the short message service center 132 includes one or more automated speech recognition (ASR) units. Another example of the short message service center 132 stores and buffers the messages, and includes functional services (short message services) such as paging, text messaging and message waiting notification. An example of the short message services includes telematic services such as broadcast services, time-driven message delivery, autonomous message delivery, and database-driven information services. Another example of the short message services includes message management features, such as message priority levels, service categories, expiration dates, cancellations, and status checks.

A public-switched telephone network is one example of the land network 140, and contains at least one wired network, optical network, fiber network, wireless network, or any combination thereof. Another example of the land network 140 is in communication with an Internet protocol (IP) network. A further example of the land network 140 connects the communications network 130 to a call center. Yet another example of the land network 140 connects a first wireless carrier system 120 with a second wireless carrier system 120, and also connects wireless carrier system 120 to a communication node or call center 150 with the use of the communication network 130. In another embodiment of the invention, a communication system references all or part of the wireless carrier system 120, communications network 130, land network 140, and short message service center 132.

Call center 150 is a location where many calls can be received and serviced at the same time, or where many calls may be sent at the same time. Example call centers are telematic call centers, prescribing communications to and from mobile vehicles 110, voice call centers, providing verbal communications between an advisor in the call center and a subscriber in a mobile vehicle, and voice activated call centers, providing verbal communications between an ASR unit and a subscriber in a mobile vehicle. The call center may contain any combination of hardware or software facilitating data transmissions between call center 150 and mobile vehicle 110. A further embodiment of the invention provides that the call center contains any of the previously described functions.

One embodiment of the call center contains switch 151. Switch 151 is connected to land network 140, and receives a modem signal from an analog modem or from a digital modem. Switch 151 transmits voice or data transmission from the communication node. Another embodiment of switch 151 can receive voice or data transmissions from mobile vehicle 110 through wireless carrier system 120, communications network 130, and land network 140, and can receive from or send data transmissions to data transmission device 152. A further embodiment of switch 151 can receive from or send voice transmissions to advisor 155 via bus system 156. Switch 151 can receive from or send voice transmissions to one or more automated speech recognition (ASR) units 157 via bus system 156.

Data transmission device 152 sends or receives data from switch 151. An example data transmission device 152 is an IP router or a modem. Data transmission device 152 transfers data to or from advisor 155, one or more communication services managers 153, one or more communication services databases 154, one or more automated speech recognition (ASR) units 157, and any other device connected to bus system 156. Another example of data transmission device 152 conveys information received from short message service center 132 in communication network 130 to communication services manager 153.

The communication services manager 153 is connected to switch 151, data transmission device 152, and advisor 155 through bus system 156. Another embodiment of the communication services manager 153 receives information from mobile vehicle 110 through wireless carrier system 120, short message service center 132 in communication network 130, land network 140, and data transmission device 152. Additionally, an embodiment of communication services manager 153 sends information to mobile vehicle 110 through data transmission device 152, land network 140, communication network 130 and wireless carrier system 120. Further embodiments of the communication services manager 153 send short message service messages via short message service center 132 to the mobile vehicle, receive short message service replies from mobile vehicle 110 via short message service center 132, send short message service requests to mobile vehicle 110, and receive from or send voice transmissions to one or more automated speech recognition (ASR) units 157.

Communication services database 154 contains records on one or more mobile vehicles 110, with a portion of communication services database 154 dedicated to short message services. Records in communication services database 154 may include vehicle identification, location information, diagnostic information, status information, recent action information, and vehicle passenger (user, customer) and operator (user, customer) defined preset conditions regarding mobile vehicle 110 and any of the communication services. Another embodiment of the invention requires that communication services database 154 provide information and other support to communication services manager 153 and automated speech recognition (ASR) units 157, and to external VRE services.

Examples of advisor 155 are real advisors and virtual advisors. A real advisor is a human being in verbal communication with mobile communication device 110. A virtual advisor is a synthesized voice interface responding to requests from mobile communication device 110. Advisor 155 provides services to mobile communication device 110, and can communicate with communication services manager 153, automated speech recognition (ASR) units 157, or any other device connected to bus system 156 or mobile communication device 110. Another embodiment of the invention may allow for the advisor 155 and ASR units 157 to be integrated as a single unit capable of any features described for either.

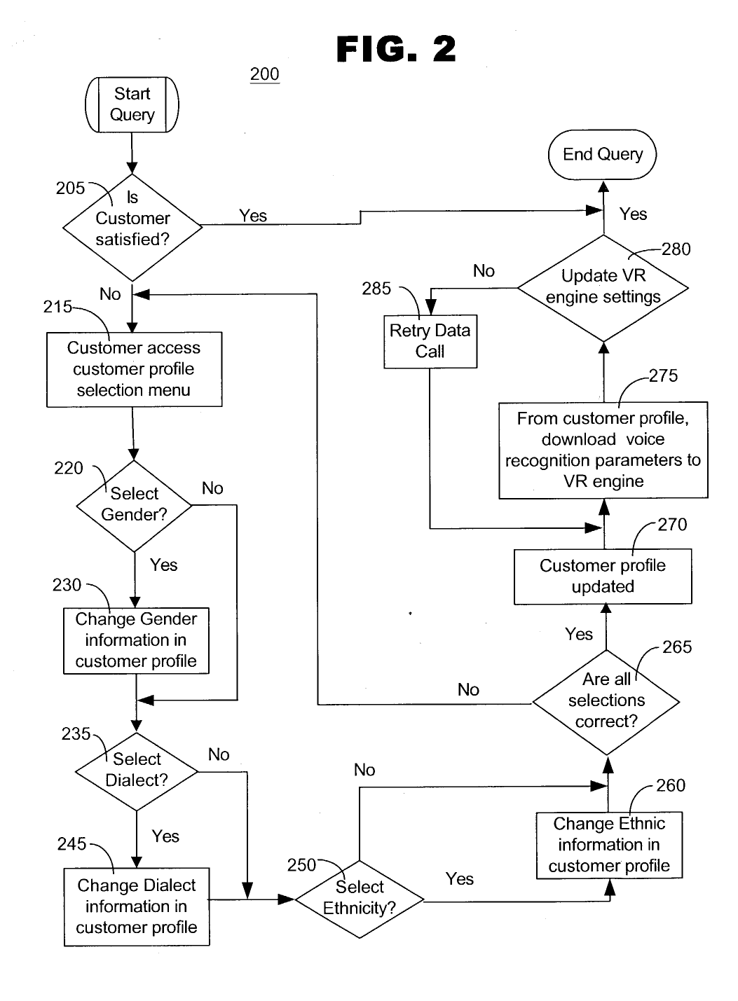

One embodiment of the invention is further illustrated in FIG. 2 as an example dialect identification based voice recognition method (method) 200, and is capable of utilizing one or more embodiments of previously described methods or systems. The method 200 enables a customer to select at least one voice recognition attribute most appropriate for him or her and download the attribute to a VR engine of a speech recognition system. This improves recognition accuracy of a speaker (customer) independent VR system through customization of the system for different genders and dialects.

Examples of VR Attributes (“attributes”) include gender, dialect, and ethnicity, but may also include additional or alternative information linking individuals (customers) to speech and voice recognition profiles. Another embodiment of the invention provides the VR attributes to be obtained from a custom's selection of attribute queries on a customer assigned Internet or Intranet Webpage. The dialect classifications for this embodiment are based on the Atlas of North American English, a dialect study produced by the Linguistics Laboratory of the University of Pennsylvania. The study classifies native speakers of North American English into the following geographic dialects: (1) Western; (2) Upper Midwestern; (3) Midland; (4) Mountain Southern; (5) Coastal Southern; (6) Great Lakes; (7) New York; and (8) New England. Additionally, the ethnic dialects, (ex. African-American, Latino, Asian American) and non-native speakers can affect the voice recognition accuracy, and therefore can be selected from a list by the customer as well.

Another embodiment of the invention provides that the parameters of the VR engines acoustic model and/or the lexical pronunciations of certain words can be changed based on the content of a large database of speech classified by gender and dialect. A further embodiment of the database provides a lookup table that associates the dialect with a particular set of VR engine parameters. The lookup table is in communication with the customers VR attribute selections and by adapting the VR engine's parameters as a function of the customers VR attribute selections, improves the voice recognition of the customers spoken characters.

Another embodiment of the invention allows for the improved voice recognition system to be used for more functions, such as controlling an audio system, a HVAC (heating, ventilation, air-conditioning) system, or a navigation system. Further, the invention is agnostic as to what the details of the speech recognition (VR) engine are. One embodiment of the invention encompasses the idea that speech recognition is difficult because no matter what type of statistical models are used (phonetic HMM, whole-word, etc.), it is difficult to cover all of the dialect diversity in the US. A speech recognition system therefore will work better for a person of a given dialect if the system is tailored to their dialect via the customers VR attribute selections.

Returning to the dialect identification based voice recognition method 200, the embodiment begins when a customer is asked or queried whether or not they are satisfied with the performance of the current voice recognition provided by their communication system 205. If they are satisfied, the query ends and no actions are taken. If however the customer is not satisfied, he or she can access a customer voice recognition profile 215 that for this embodiment is in the form of a selection menu. The customer voice recognition profile selection menu may be provided by but is not limited to a software program, a Web page, a voice activated menu, an internal feature of a VR system, or may be provided by operator assistance through a network or communication connection.

The embodiment of FIG. 2 allows for the selection of gender 220. If a gender is selected, a temporary modified customer voice recognition profile is created containing the new VR attribute 230. After the modified customer voice recognition profile has been created, or if no gender selection is made, the method 200 provides for a dialect selection 235. If a dialect selection is made, either the temporary modified customer voice recognition profile is created containing the new VR attribute, or the new VR attribute is added to an existing modified customer voice recognition profile 245. After the modified customer voice recognition profile has been created or appended to, or if no dialect selection is made, the method 200 continues with an ethnicity selection 250. If an ethnic selection is made, again either the temporary modified customer voice recognition profile is created containing the new VR attribute, or the new VR attribute is added to an existing modified customer voice recognition profile 260. After the modified customer voice recognition profile has been created or appended to, or if no ethnic selection is made, the method 200 continues with a verification selection of the previous attributes chosen 265. If the VR attributes contained in the modified customer voice recognition profile are not acceptable to the customer, the method 200 returns to the customer voice recognition profile selection menu 215. In another embodiment of the invention, if the attributes contained in the modified customer voice recognition profile are not acceptable to the customer, the customer voice recognition profile is created using a default setting. In another embodiment of the invention, the default settings may be formed as a function of the geographic and demographic information associated to an area code or a GPS determined location.

If the attributes contained in the modified customer voice recognition profile are acceptable, the modified customer voice recognition profile of the method 200 becomes the customer voice recognition profile 270. The voice recognition profile or its modified file is transmitted to the VR engine 275 either by a wireless or physical connection. The VR engine is amended as a function of the customer voice recognition profile as previously described 280. If the VR engine cannot amend the new attribute information, a data call retry is enabled 285 and the method 200 returns to the transmission to the VR engine 275 until the VR engine is amended.

The above-described methods and implementation for voice recognition through dialect identification and associated information are example methods and implementations. These methods and implementations illustrate one possible approach for providing a customer voice recognition profile in a meaningful way to improve a VR engine. The actual implementation may vary from the method discussed. Moreover, various other improvements and modifications to this invention may occur to those skilled in the art, and those improvements and modifications will fall within the scope of this invention as set forth below.

The present invention may be embodied in other specific forms without departing from its spirit or essential characteristics. The described embodiments are to be considered in all respects only as illustrative and not restrictive.

We claim:

1. A method for automated speech recognition comprising:
accessing a customer voice recognition profile;
selecting a voice recognition attribute;
creating a modified customer voice recognition profile as a function of the voice recognition attribute; and
amending a voice recognition engine as a function of the modified customer voice recognition profile.

2. The method of claim 1 wherein the voice recognition attribute is selected from a group consisting of a gender, a dialect, and an ethnicity.

3. The method of claim 2 wherein the dialect is selected from a group consisting of a western region, an upper midwestern region, a Great Lakes region, a New England region, a New York region, a midland region, a mountain southern region, and a coastal southern region.

4. The method of claim 1 further comprising transmitting the modified customer voice recognition profile to the voice recognition engine wherein the modified customer voice recognition profile and the voice recognition engine are not in physical communication.

5. The method of claim 1 further comprising creating a customer voice recognition profile if the customer voice recognition profile is nonexistent.

6. The method of claim 1 further comprising providing a voice recognition engine parameter as a function of the voice recognition attribute; and amending the voice recognition engine as a function of the voice recognition engine parameter.

7. The method of claim 1 further comprising replacing the customer voice recognition profile with the modified customer voice recognition profile.

8. The method of claim 1 further comprising amending the voice recognition engine as a function of the customer voice recognition profile wherein no voice recognition attribute is selected.

9. A system for automated speech recognition comprising:
means for accessing a customer voice recognition profile;
means for selecting a voice recognition attribute;
means for creating an modified customer voice recognition profile as a function of the voice recognition attribute; and
means for amending a voice recognition engine as a function of the modified customer voice recognition profile.

10. The system of claim 9 further comprising means for transmitting the modified customer voice recognition profile to the voice recognition engine wherein the modified customer voice recognition profile and the voice recognition engine are not in physical communication.

11. The system of claim 9 further comprising means for creating a customer voice recognition profile if the customer voice recognition profile is nonexistent.

12. The system of claim 9 further comprising means for providing a voice recognition engine parameter as a function of the voice recognition attribute; and means for amending the voice recognition engine as a function of the voice recognition engine parameter.

13. The system of claim 9 further comprising means for replacing the customer voice recognition profile with the modified customer voice recognition profile.

14. The system of claim 9 further comprising means for amending the voice recognition engine as a function of the customer voice recognition profile wherein no voice recognition attribute is selected.

15. A computer readable medium storing a computer program for automated speech recognition comprising:
computer readable code for accessing a customer voice recognition profile;
computer readable code for selecting a voice recognition attribute;
computer readable code for creating an modified customer voice recognition profile as a function of the voice recognition attribute; and
computer readable code for amending a voice recognition engine as a function of the modified customer voice recognition profile.

16. The computer program of claim 15 further comprising computer readable code for transmitting the modified customer voice recognition profile to the voice recognition engine wherein the modified customer voice recognition profile and the voice recognition engine are not in physical communication.

17. The computer program of claim 15 further comprising computer readable code for creating a customer voice recognition profile if the customer voice recognition profile is nonexistent.

18. The computer program of claim 15 further comprising computer readable code for providing a voice recognition engine parameter as a function of the voice recognition attribute; and computer readable code for amending the voice recognition engine as a function of the voice recognition engine parameter.

19. The computer program of claim 15 further comprising computer readable code for replacing the customer voice recognition profile with the modified customer voice recognition profile.

20. The computer program of claim 15 further comprising computer readable code for amending the voice recognition engine as a function of the customer voice recognition profile wherein no voice recognition attribute is selected.
